(19) United States
(12) Patent Application Publication
(10) Pub. No.: US 2016/0249084 A1
(43) Pub. Date: Aug. 25, 2016

(54) MANAGING AD CAMPAIGNS VIA MOBILE DEVICES

(71) Applicant: Yahoo! Inc., Sunnyvale, CA (US)

(72) Inventors: Shira Dawn Kates, Brookline, MA (US); Paulius Dragunas, San Jose, CA (US); Assaf Broitman, San Francisco, CA (US); Elizabeth J. Richard, Dallas, TX (US); Joshua Nisenson, San Jose, CA (US); Brady Patrick Sammons, Walnut Creek, CA (US)

(73) Assignee: Yahoo! Inc., Sunnyvale, CA (US)

(21) Appl. No.: 14/631,152

(22) Filed: Feb. 25, 2015

(51) Int. Cl. H04N 21/2547; G06F 3/0484; H04N 21/24; G06F 3/0482; H04N 21/81; H04N 21/854

(52) U.S. Cl. CPC H04N 21/2547; H04N 21/812; H04N 21/854; H04N 21/2407; G06F 3/0482; G06F 3/0484

(57) ABSTRACT

In a video advertisement system in which video advertisements are provided to users based on a bidding process in which multiple advertisers compete for video ad placement based on their video ad campaigns, a mobile device module under control of an ad campaign manager controls execution of the plurality of advertisement campaigns by displaying, on a user interface (UI), a user-selectable menu that lists at least one video advertisement campaign, receiving, from the UI, a review request for at least one video advertisement campaign, and playing out on the UI, upon receiving the selection, a creative associated with the at least one video advertisement campaign.

### TECHNICAL FIELD

This disclosure relates to digital video advertisement insertion technologies.

### BACKGROUND

Many companies use online advertising networks to advertise to users. Online advertising networks communicate advertisement opportunities to third parties. Advertisement opportunities occur when devices view content on a content publisher's website. Advertising networks seek to efficiently match advertisement opportunities with advertisers who wish to advertise to a particular user.

Advertisement bidding exchanges facilitate the matching of advertisers with advertisement opportunities.

### SUMMARY

The present disclosure provides techniques for controlling advertisement campaigns using mobile devices.

In one example aspect, a method is disclosed of facilitating management and control of a plurality of video advertisement campaigns in which video advertisements are distributed to a plurality of user devices in an auction-based bidding advertisement insertion system. The method being implemented at a mobile device having a touchscreen display. The method includes displaying, on a user interface (UI), a user-selectable menu that lists at least one video advertisement campaign, receiving, from the UI, a review request for at least one video advertisement campaign, and playing out on the UI, upon receiving the selection, a creative associated with the at least one video advertisement campaign.

In another example aspect, a video advertisement insertion system is disclosed. The system includes a bidding server that facilitates display of video advertisements to multiple user devices. The system includes an advertiser's server that bids for placement of video advertisements by the bidding server according to a plurality of video advertisement campaigns. The system includes a mobile device module that controls execution of the plurality of advertisement campaigns by displaying, on a user interface (UI), a user-selectable menu that lists at least one video advertisement campaign, receiving, from the UI, a review request for at least one video advertisement campaign, and playing out on the UI, upon receiving the selection, a creative associated with the at least one video advertisement campaign.

These, and other, aspects and features are disclosed herein. Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

### BRIEF DESCRIPTION OF THE DRAWINGS

FIG. 1 shows an example of a bidding-based video advertisement exchange system.

FIG. 2 shows an example of a bidding-based video advertisement exchange system.

FIG. 3 shows an example of messages exchanged for campaign and line item statistics reporting.

FIG. 4 shows an example of messages exchanged for campaign and line item data reporting.

FIG. 5 shows an example of messages exchanged to allow a campaign manager to log in.

FIG. 6 shows an example user interface (UI) of a campaign manager's mobile device.

FIG. 7 shows an example UI of a campaign manager's mobile device.

FIG. 8 shows an example UI of a campaign manager's mobile device.

FIG. 9 shows an example UI of a campaign manager's mobile device.

FIG. 10 shows an example UI of a campaign manager's mobile device.

FIG. 11 shows an example UI of a campaign manager's mobile device.

FIG. 12 shows an example UI of a campaign manager's mobile device.

FIG. 13 shows an example UI for playing a video ad campaign creative on a campaign manager's mobile device.

FIG. 14 shows an example method of controlling a video ad campaign from a campaign manager's mobile device.

FIG. 15 shows an example video ad insertion system in which a campaign manager's mobile device is used to control a video advertisement campaign.

Like reference symbols in the various drawings indicate like elements.

### DETAILED DESCRIPTION

In the following detailed description, numerous specific details are set forth to provide a full understanding of the present disclosure. The specific examples or embodiments of the present disclosure may be practiced without some of these specific details. In other instances, certain well-known structures and techniques have not been shown or described in detail but are nonetheless part of the present disclosure.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Online advertisements are a significant source of revenue for many web sites and other online information and service providers. At the same time, being able to reach potential users via online advertisements can be a very effective advertisement medium for advertisers. Video advertisements can be an effective multimedia tool, but can be expensive to distribute. A stakeholder paying for the distribution of online management may thus desire to control how many advertisements are shown to whom and at what time.

In today's online advertisement distribution networks, ad bidding platforms are often used by which opportunities to display advertisements to users are sold on an automated bidding platform to a highest bidder. Because online users are using the internet around the clock and around the globe, correspondingly, advertisements are being shown to users around the clock. Therefore, advertisers may desire to control the distribution and play-out of their advertisement campaigns on an around the clock, 24/7 basis.

Some present-day advertisement bidding platforms allow advertisers and ad campaign managers to view the playout of their ad campaigns using client devices such as laptops and mobile phones. However, these systems are read-only systems and do not allow users to control an ad campaign by interacting with a bidding platform or an advertisement server. Further, viewing multiple ad campaigns using a small screen device is cumbersome and can lead to unsatisfactory user experience. Furthermore, mobile devices often have limited bandwidth connectivity available with the servers and thus may not show the most current playout statistics at all times.

The techniques disclosed in the present patent document overcome these operational limitations, and others. In some disclosed embodiments, a mobile application installed on a mobile device such as a smartphone, a tablet or other battery-operated device may be used to view and control ad campaigns. In some embodiments, a large amount of data may be continuously updated for easy viewing and control access from a small screen, limited power device. These, and other, aspects are described in the present document.

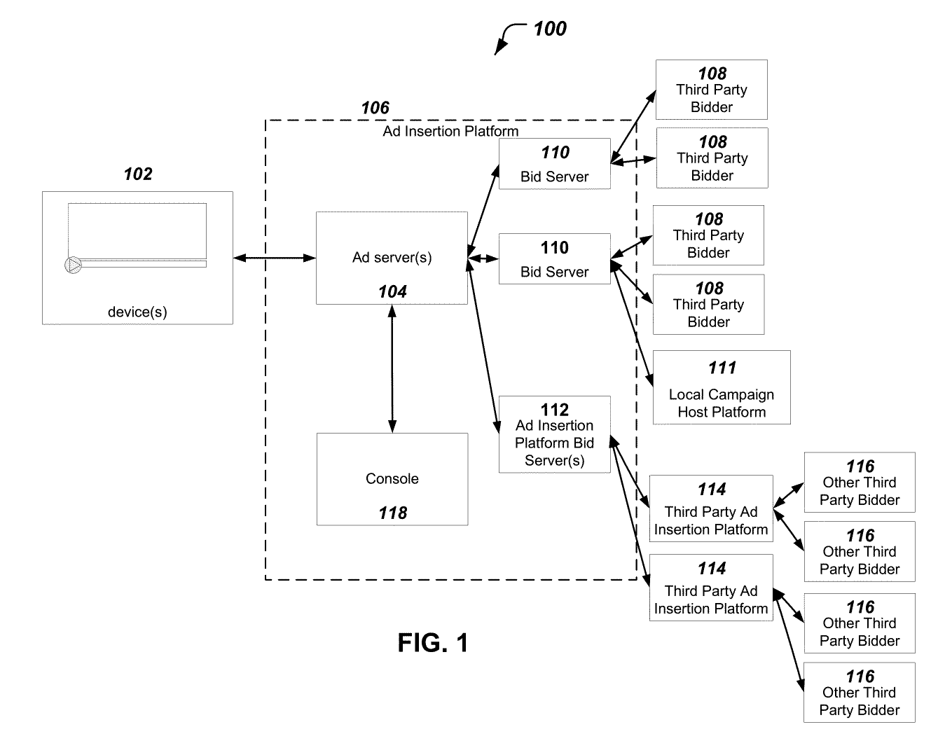

FIG. 1 illustrates an example of an online video advertisement insertion architecture 100. A device 102 is communicatively coupled to an ad server 104 of a video ad insertion platform 106. The ad insertion platform 106 in the illustrated embodiment includes the ad server 104, a console 108, one or more bid servers 110, and an ad insertion platform bid servers 112. The ad server 104 provides a front end entry point to the video ad insertion platform 106.

The device 102 can be communicatively coupled via a wired connection, a wireless connection, or via any type of communications network such as the internet. The device 102 is an example of a client device. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device such as the device 102 may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device such as the device 102 may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

A computing device such as the ad server 104 and other servers illustrated or described herein may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Various monetization techniques or models may be used in connection with online advertising, including advertising associated with user search queries, or non-sponsored search advertising, including graphical or display advertising or video advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various examples, advertisers may pay based at least in part on any of various metrics associated with advertisement delivery or performance, or associated with measurement or approximation of particular advertiser goal(s). For example, examples may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

A process of buying or selling online advertisements may involve a number of different entities, including advertisers, publishers, agencies, networks, or developers. To simplify this process, organization systems called ad exchanges or advertising platforms may associate advertisers or publishers, such as via an advertising platform to facilitate buying or selling of online advertisement inventory from multiple ad networks. Ad network refers to aggregation of ad space supply from publishers, such as for provision en masse to advertisers.

In FIG. 1, the device 102 interfaces with a publisher (not shown) to view content such as a video on the device 102. A communication is sent to the video ad insertion platform 106 whenever there is an opportunity to play an advertisement to a user of the device 102. Information relating to the publisher, device 102, and advertisement opportunity is passed to the ad server 104. The ad server 104 processes this information and provides the advertisement opportunity to one or more third-party bidders 108 via the one or more bid servers 110. The bid servers 110 provide a bidding interface between third party bidders 108 and the video ad insertion platform 106. Any number of third-party bidders 108 can be communicatively coupled to any number of bid servers 110. Each third-party bidder 108 has a chance to place a bid on the advertisement opportunity. The winning bidder receives the opportunity to deliver a video advertisement to the device 102.

In an embodiment, the third-party bidders 108 are advertisers who wish to place advertisements on client devices 102. The third-party bidders 108 process the advertisement opportunity, use their internal logic to determine whether they want to bid on the advertisement opportunity and how much they want to pay, and present a bid response to the bid server 110. In an embodiment, the third-party bidders 108 are advertising agencies that have relationships with one or more advertisers. Similarly, the advertisement agencies use their own logic to determine whether they want to bid on the advertisement and place a bid accordingly. In another embodiment, the third party bidders 108 include a mix of advertisers and advertising agencies.

In an embodiment, third party bidders 108 are given a predetermined time period to respond with a bid response. Bid responses from the third party bidders 108 who do not respond within the predetermined time period are ignored. Placing a predetermined time limit on bid responses prevents the appearance of publisher latency. This prevents a user on a device 102 from navigating away from a particular publisher's webpage before the advertisement or publisher content has been displayed.

After a winning bid has been determined, the ad insertion platform 106 informs the device 102 that an advertisement will be placed. The winning bidder is notified that they have placed the winning bid and is provided with information that allows them to transmit a video advertisement to the device 102. In an embodiment, the ad insertion platform 106 places the advertisement on the device 102. In an embodiment, information involved with the transaction is logged in a database, a series of files, or other format known in the art. The information logged can include bid amount, advertisement, publisher information, advertiser information, date, time, domain, subject matter of advertisement, subject matter of publisher content, and other information.

In an embodiment, a third party ad insertion platform bid server 112 is communicatively coupled to one or more other third party ad insertion platforms 114. The other third party ad insertion platforms 114 may be other advertisement insertion platforms offered by other vendors such as TubeMogul, Yahoo, etc. The third party ad insertion platforms 114 are communicatively coupled to one or more other third party bidders 116. In an embodiment, the third party ad insertion platforms 114 are communicatively coupled to one or more bid servers 110 that service the one or more third party bidders 108. Communication between the ad insertion platform 106 and other devices may be over one or more networks including the internet.

Advertisement opportunities are communicated to one or more third party ad insertion platform bid servers 112 as well as the one or more bid servers 110. It is sometimes the case that a particular ad insertion platform 106 has relationships with particular third party bidders 108 and not with other third party bidders 116 that have relationships with other third party ad insertion platforms 114. Providing advertisement opportunities to one or more third party ad insertion platforms 114 allows the ad insertion platform 106 to maximize the reach of an advertisement opportunity to the other third party bidders 116. This increases the chance that a particular publisher and advertiser will be efficiently matched.

In an embodiment, the console 118 allows third parties or an administrator to view information relating to the ad insertion platform 106. The console 118 allows users to access one or more databases stored in memory (not shown) and to view diagnostic information relating to the ad insertion platform 106. In an embodiment, the diagnostic information includes graphs and statistics relating to latency and timeout performance of the system and the communication of bid requests. In an embodiment, the console 118 is accessible via one or more networks including the internet.

In an embodiment, the ad insertion platform 106 provides ad data to the device 102 using a Digital Video Ad Serving Template (VAST) format. VAST is a specification by the Interactive Advertising Bureau (IAB) that provides a common ad response format for video players that enables video ads to be served across all compliant video players. A VAST document provided by a RTB system includes a media file that points to a client side component used to collect video ad activities on the client side.

In another embodiment, the content publisher utilizes the (Video Player Ad-Serving Interface Definition (VPAID). VPAID establishes a common interface between video players and ad units to allow interactive in-stream ad experiences. VPAID also provides a communication protocol between video players and ad units to allow a single executable ad. The executable ad incorporates software logic that is executed as part of ad playback. The ad can be displayed in-stream with the content publisher's video content.

In an embodiment, the ad insertion platform 106 is communicatively coupled to one or more third-party tracking and measurement services (e.g., Nielsen, comScore, Telemetry, etc.). The third party services provide various additional information such as demographic information about users, popularity of video and audio content, effectiveness of an advertisement campaign, and other tracking and measurement services to the ad insertion platform 106.

In an embodiment, a local campaign host platform 111 is coupled to a bid server 110. The local campaign host platform 111 determines whether it wants to serve the one or more stored advertisements (not shown) to the device 102 based on internal logic. Advertisers or advertisement agencies place rules on the placement of stored advertisements on the local campaign host platform 111. In an embodiment, the rules associated with the stored advertisements on the local campaign host platform 111 are associated with a campaign set by an advertiser, advertisement agency, or other entity that has a business relationship with the advertiser. The rules can include information relating to the desired publisher, desired content of the publisher for the advertisement, the device, the user using the device, the user's demographic profile, desired bid amount or range, and other rules associated with the ad placement. In an embodiment, the bids associated with the stored advertisements of the local campaign host platform 116 are compared with the bid response of third party bidders 108. In another embodiment, the local campaign host platform 111 delivers a store advertisement to the device 102 without the ad insertion platform 106 presenting the bid request to the third party bidders 108 in the case that the bid for the stored advertisements is above a certain predetermined threshold. In an embodiment, the stored advertisements can be stored locally, on the cloud, on a dedicated server, or any other storage platform.

FIG. 1 is not intended to be limiting to the particular number of servers or division of server functions (e.g., ad server 104, bid server 110, third party ad insertion platform bid servers 112). Any one of the bid servers 110 can perform the functions of the third party ad insertion platform bid servers 112. Any number of third party bidders 108 and third party ad insertion platforms may be communicatively coupled to any number of bid servers 110 or ad insertion platform bid servers 112.

Any one of the ad servers 104, bid servers 110, third party ad insertion platform bid servers 112, or console 118 may be on a single ad insertion platform offered by a single vendor (e.g., the BRX platform offered by Brightroll, Inc.). Any one of the ad servers 104, bid servers 110, or third party ad insertion platform bid servers 112 may be implemented in individual software packages, application programming interfaces, dedicated servers, or on the cloud.

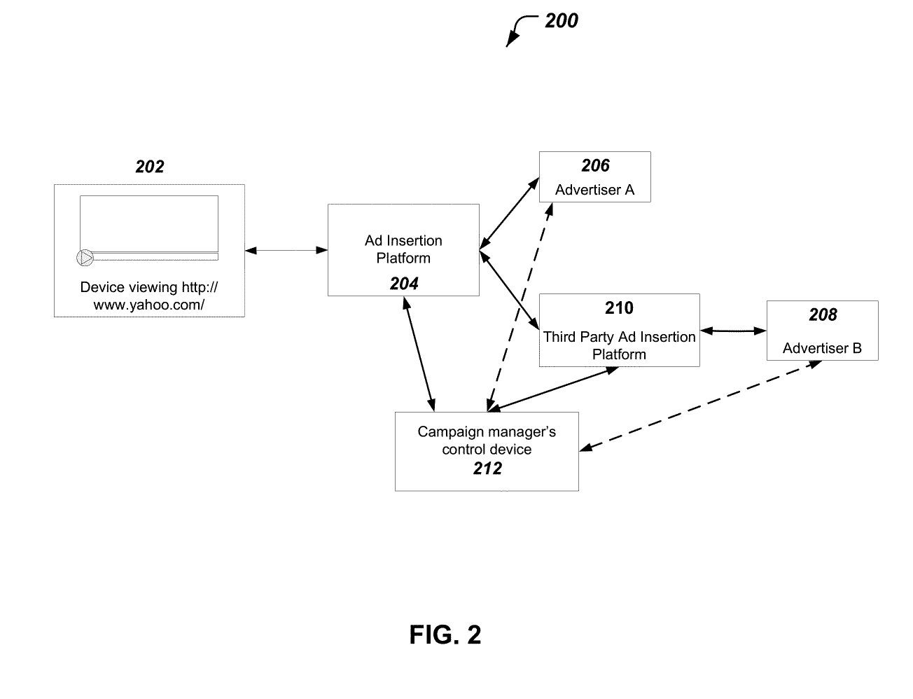

FIG. 2 illustrates a simplified example of an online video advertisement insertion architecture 200 where a device 202 is viewing content on, e.g., www.yahoo.com. In this example, an ad insertion platform 204 may be situated to place video advertisements to user devices 202 from Advertiser A 206, with whom the operator of the ad insertion platform 204 may have a direct business relationship. The ad insertion platform 204 may further be able to place advertisements for Advertiser B 208, the operator of which might have a direct business relationship with a third party ad insertion platform 210 (e.g., similar to third party ad insertion platform 114 described above in conjunction with FIG. 1).

A campaign manager may be able to use a mobile device 212 to control and monitor ads placed to the user device 202 for advertisers 206, 208. For control and monitoring, the campaign manager's control device, a data processing system such as a mobile device 212 may be communicatively coupled to one or more of the ad insertion platform 204, the third party ad insertion platform 210, and advertisers 206, 208 by means of any suitable wireless or wireline network.

FIG. 2 is presented as a simplified example to aid in the understanding of the disclosure. The disclosed technology encompasses any number of relationships with any number of advertisers, advertisement agencies, third party ad insertion platforms and campaign manager's mobile device 212.

Use Case Example—App Accessibility and Management.

A campaign manager may want to access the mobile application (app) on his mobile phone or other device to buy and manage his video advertising campaigns on-the-go, using his mobile device. The campaign manager's mobile device may have an application installed on the device. The installed application may have the appropriate level of authentication (e.g., an Apple License ID).

In this example, the video advertising campaign includes media such as audio and video for playout to an end user device. The media may be in a geographically distant location, requiring a time delay to access and communicate from the location to the end user device. Thus, a server may experience large latency, e.g., 5 seconds.

The application on the campaign manager's device may be able to interact with an advertising platform server using application programming interfaces (APIs) that allow read/write/modify access to line items, ad campaigns and so on.

3. Acceptance Criteria

The mobile app, in some embodiments, should be registered with Apple Inc. using a previously granted Apple License ID so that the app can be distributed to users. As a campaign manager, the mobile app may be required to work in conjunction with versions of the iOS operating system in order to run on an iPhone or other devices sold by Apple, Inc. The app may work with other operating systems, as well, such as Android. The campaign manager may download the mobile app via a private link to begin to use the mobile app on his mobile device. The campaign manager should be able to access the mobile app from anywhere with a secure connection so that the campaign manager can beta test the app at client's offices, at home, or on-the-go. The campaign manager should be able to log-in to the mobile app using log-in credentials provisioned to the campaign manager. Further, the campaign manager may access only data of his employer or organization when logged in to manage advertising campaigns. For the campaign manager, the mobile app's user interface should respond in under 5 seconds so that the campaign manager can have a seamless user experience without excessive wait times

Use Case Example—Campaign Management

A user may want to manage time-sensitive tasks from her mobile device. The management may be related to viewing, editing, adding and deleting line items, ad campaigns, and so on. Due to the time sensitive nature of data, the mobile app may provide data freshness information to the user. The data freshness information may include a time stamp that indicates to the user the last time this data was renewed or confirmed to be the most recent data.

In some embodiments, the mobile app may display line item production data by preset date ranges to manage campaigns with different advertising flight dates. Example time ranges may include, e.g., Preset, Today, Yesterday, Month to Yesterday, Lifetime, and so on.

In some embodiments, a line item's production data (e.g., listed below) may be displayed to the ad campaign manager so facilitate easy and rapid monitoring of campaign key performance index (KPI) goals and delivery. The displayed information may include one or more of: combined click through rate, completion rate, effective cost per mille (eCPM), impressions, money spent so far, budget left, etc.

In some embodiments, a timestamp is provided in the user interface of a mobile device to help describe the freshness of data. The time stamp may be provided as an always-visible option, or a hidden value that is made visible upon receiving a gesture such as a menu selection on finger tap.

In some embodiments, a visual indication may be provided for a line item status to verify if line item(s) are active or inactive.

In some embodiments, the mobile device may provide support for campaign dimension, custom date range selection, and so on.

Use Case Example—Search

In some embodiments, a campaign manager may want to search for a line item across the organization for which he is managing ads, so that he can easily navigate and save time when managing a large number of ad campaigns. In some examples, a campaign manager may manage 10-100 or more campaigns.

In some embodiments, the user interface of a mobile device may present to the campaign manager user an alphanumeric keyboard by which the user can input alphanumeric characters to search for a line item across his organization or campaigns. In some embodiments, the user can search for a line item by typing in a name and find related results. In some embodiments, the mobile device may provide the results to the user in a short time span, e.g., less than 5 seconds, and may also navigate the user to a line item of interest.

Use Case Example—Event Tracking and Reporting

At the back-end, e.g., on a network-side server that provides to the user's mobile device the user requested information, a developer of the system may want to monitor and analyze user information so that the campaign manager can both strengthen the product's business case that resented to product or business managers and to build or iterate features to ensure product market fit.

For example, some embodiments may allow a system administrator to access user log-in information for the mobile app to track user onboarding and adoption. Some of the parameters used in analyzing user behavior include: Name, Date, Time, Time spent, Website visits, app downloads, etc.

In some embodiments, additional user behavior such as searches performed, date ranges, views of production data, activation or deactivation, favorite, push notifications sent to the user, steps a user takes after receiving a push notification etc., may be monitored, recorded and reported when requested.

Use Case Example—Activate/Deactivate

In some embodiments, the mobile app may allow a user to activate or deactivate a line item to pause a campaign to perform time sensitive changes. In some embodiments, where a line item is given a status-indicating color on the display of the mobile device, a line item's status icon in the user interface of the mobile app may be caused to change to its respective color in under ˜5 seconds for providing a visual feedback to the user that the desired activation or deactivation has been successful. The same change of status may also be reflected in the user's other consoles, e.g., console on a large-screen computer that the user uses to control the ad campaign.

In some embodiments, the user is allowed to perform bulk activation and deactivation of multiple ad campaigns. To perform such activation and deactivation, the user may be able to use, e.g., a “select all” menu for available ad campaigns or line items, a wild card character to specify multiple ad campaigns or line items.

Use Case Example—Favorite

In some embodiments, the mobile device may provide a way by which a campaign manager can select his “favorite” line items to save time managing a high volume of campaigns. Similarly, the mobile device may also provide a way by which the campaign manager can designate some items to be “de-favorite” line items, or line items that are not to be included in the list of favorite line items, to save time managing a high volume of campaigns.

In some embodiments, the system may allow dynamic selection or de-selection of favorites. This may include, for example, automatically assigning importance to line items based on whether they were “recently added,” “frequently viewed,” “under pacing,” etc.

Use Case Example—Push Notifications

In some embodiments, the system enables a push notification sent to a user's mobile app. Some examples include alerts about campaign status to allow the use to make updates to her line items. In some embodiments, a user may be able to opt-in and opt-out of campaign alert push notifications via a pop-up in order to get real-time campaign alerts on her mobile device. In some embodiments, the pop-up enabling the push notification may include the description about the push notifications so that an operator can make a decision to opt-in\ or opt-out. In some embodiments, a campaign manager may be able to choose a default threshold so that the campaign manager can receive alerts via a push notification indicating a condition, such as a line item falling outside a default threshold.

In some embodiments, upon receiving a push notification, a user, e.g., a campaign manager, may have the option to swipe the push notification to land at the user interface for performing a specific, pre-defined, action such as editing the line item, checking for a problem with a video ad creative when the push notification indicates a problem, and so on. A menu screen from the app may enable user selection of which tasks should be accessible to the user upon swiping on push notification of a particular event.

For example, when pacing is monitored, the user may generate the following classes to receive a notification when a given line item or ad campaign is going faster or slower than a target rate: for example, Under delivery (<90% pacing), On track (90%-105% pacing), Over delivery (>105% pacing), Combined click through rate (<1.0%), Completion rate (<60%), eCPM (>$8), etc. Other examples may be implemented as well to achieve particular design goals or performance requirements. In some embodiments, the system may alert a user via a push notification on his mobile device if a line item falls outside of a default threshold, thereby enabling the user to passively track campaign performance.

In some embodiments, the system may provide a user interface menu by which the user is able to schedule how often to receive push notifications so notifications are sent when required. Examples of possible notification frequencies could be: Real-time, Daily at x time, Weekly at y time, Monthly at z time (where x, y, z are user-specifiable times). In some embodiments, the push notification is provided by including a link or shortcut to allow the user to directly edit a specific line item for which the push notification has been issued.

In some embodiments, a user may be able to monitor line item pacing percentage by the below date ranges. The pacing percent may be calculated using the following equation:

pacing %=(delivered amount)/[(target amount/total days in flight)*(number of days of delivery thus far)]*100

A user may be able to specify the time window over which the pacing calculation is made. For example, options may include—Preset, Today, Yesterday, Month to Yesterday, Lifetime, and so on.

In some embodiments, the system may be designed to support up to a pre-determined number of thresholds (e.g., 6) per line item.

The various features and capabilities of the system may be interactive with the user via a voice recognition engine. Using voice recognition, the user may be able to control the system or the app on the user device with commands such as speak to search, speak to specify favorite, speak to update, etc.

In some embodiments, a campaign manager may be able to alert other colleagues that are in an office, or geographically close to the office, to control issues arising in the campaign. The mobile nature of the campaign manager's device along with the ability to determine its position using a scheme such as a built-in global positioning system (GPS) receiver or wireless signal sources such as cellular base stations and wireless network access points, can be advantageously used to determine the location of campaign manager when a notification that needs a user's attention and input is generated by the system. The notification may be, for example, escalated to someone whose geographical location indicates that that person is in the office. To facilitate such escalation, all campaign managers who use the app may be allowed to approve sharing of their location from their mobile device. If a campaign manager gets a notification while away, he can select a user interface option such as clicking a menu item labelled “Find CMs near computer” which will pull all campaign managers who are at the office.

In some embodiments, such as when the operator device is a touchscreen device, the system may allow for user interface gestures such as finger swipe or finger tapping to implement certain control aspects of the online video advertisement insertion system. In some embodiments, push notifications may be organized on the user interface so that Swipe and Gestures features are sufficient for the user to interact with the notification. In other words, without using an alphanumeric keyboard, a user may be able to perform tasks such as swipe to favorite, intelligent filters only using fingers, and so on. Some smartphones in today's marketplace also offer the feature of user authentication via user's fingerprint. In some embodiments, a user may be able to login to the app with her fingerprint, approve budget changes with her fingerprint and/or perform additional functions in which user authentication is performed via fingerprinting.

In some embodiments, ad campaign control could be adaptive to the orientation of the phone. For example, when the phone is in a “portrait” viewing mode, e.g., long vertical, short horizontal display, more line items may be shown but less detail per line item may be shown, compared to when the phone is in landscape mode, at which, fewer line items may be displayed, but additional information may be included on the line items, such as graphs and links.

Certain advantageous aspects include, but are not limited to, being able to check player size and comparing it with target audience, being able to monitor multiple key performance indicators (KPI). Using the system and method described herein, an ad campaign manager may be able to check pacing with third party data.

In some embodiments, a secondary operator device, such as a wearable device like an e-watch, may be used to control start and stop actuations, such as activate and deactivate operations, for an ad campaign. A secondary device may be a device that is not directly in communication with ad serving infrastructure but has a first physical layer connection to another operator device, e.g., a mobile phone, over a short range communication channel. The operator device may in turn be able to communicate with the operator device that manages the delivery of content through the ad exchange platform.

In some embodiments, an activity stream may show the operator, in reverse order, all of the things the operator has done in a defined last time window, such as the last couple of days. The operator can switch to the predictive stream as a way of reminding the operator what the operator will most likely need to do in the coming days as well. In some embodiments, the operator won't have to set reminders/calendar appointments for it, the app will predict what actions are required. This can be done, for example, by checking metrics for a campaign that is finishing, deactivating a campaign that is under-delivering so you can analyze it, checking KPIs on the first day after a new line item has been activated and on and on.

In some embodiments, location based escalation may be performed. In some embodiments, all authorized operators may have a corresponding access control privilege. For example, some operators may only be able to access the performance data for the ad campaign using a desktop computer, while others may be authorized for the use of mobile devices also. Similarly, some operators may be permitted to access the ad campaign only during their working hours while other may be able to access the ad campaign around the clock. The system may have the ability to find a campaign manager that is at the office, home, or another location, or is just marked as available for desktop access so the system can escalate an issue that requires more than the limited settings the app allows. Such actions may include targeting changes, block list etc., as well as others. In some embodiments, the system may use location information about a campaign manager and decide based on his current location whether or not the campaign manager is allowed to access the ad system as requested.

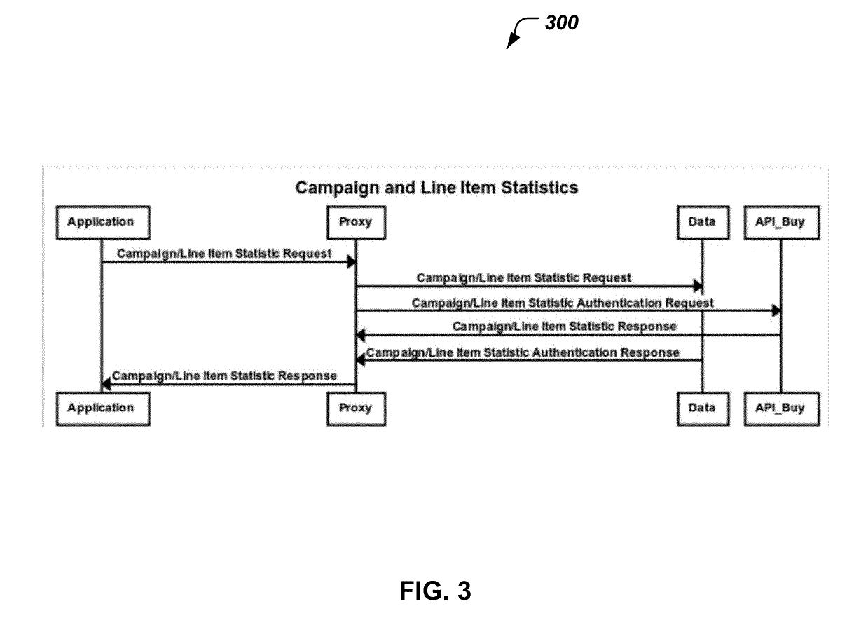

FIG. 3 shows an example communication flow 300 of messages exchanged for campaign and line item statistics reporting. The messages are shown to be exchanged among an application, a proxy module, a data module and an API_buy module that represents system functionality. The example communication flow 300 shows that the application, which may be a mobile app installed on a campaign manager's mobile device, may issue a campaign or line item statistics request to a corresponding proxy. The proxy may be a software code running on a server in an advertising management system or may be running at the campaign manager's desktop. The proxy may in turn send a corresponding request to the source of data, which may be a server in the ad insertion system, and also request authentication of this request by sending a message to the API_buy module. The proxy may subsequently receive authentication via a response and the requested data via a response from the data source and relay this information to the application that requested the information.

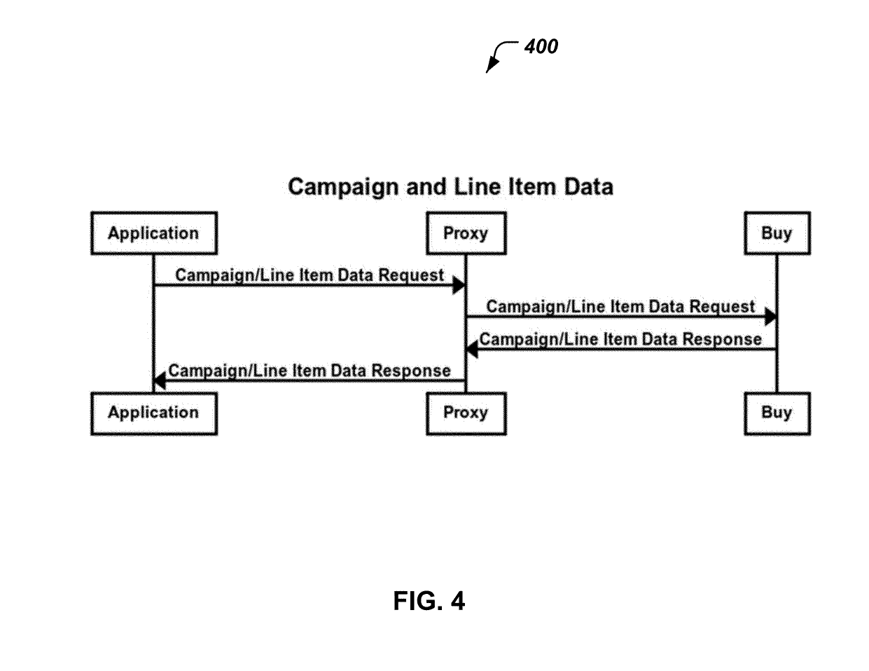

FIG. 4 shows an example communication flow 400 of messages exchanged for campaign and line item data reporting. An application, e.g., a mobile app, may request line item data from a proxy module, e.g., as discussed with respect to FIG. 3. The proxy module may then issue a data request to a buy module to receive the desired data and may in turn receive the desired data in a response to the proxy, which is then sent to the requesting application.

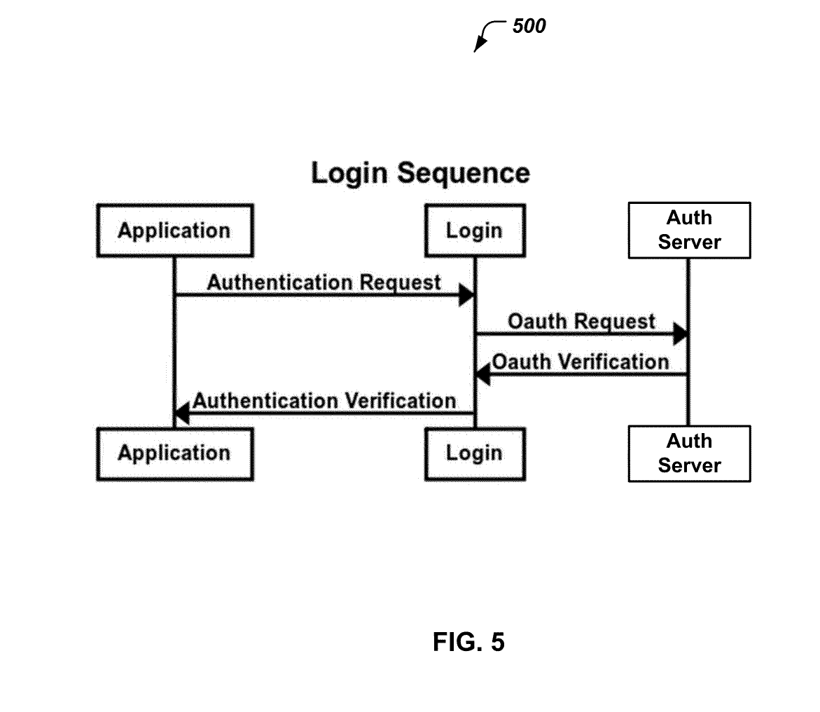

FIG. 5 shows an example communication flow 500 of messages exchanged to allow a campaign manager to log into the system to be able to use the mobile app installed on the mobile device. For example, at the beginning of use, the app may send an authentication request to a login module, which may then contact an authentication server and receive a response, e.g., authentication passed or failed. The login module then may send back the result of the authentication to the application.

Example Menu Structure

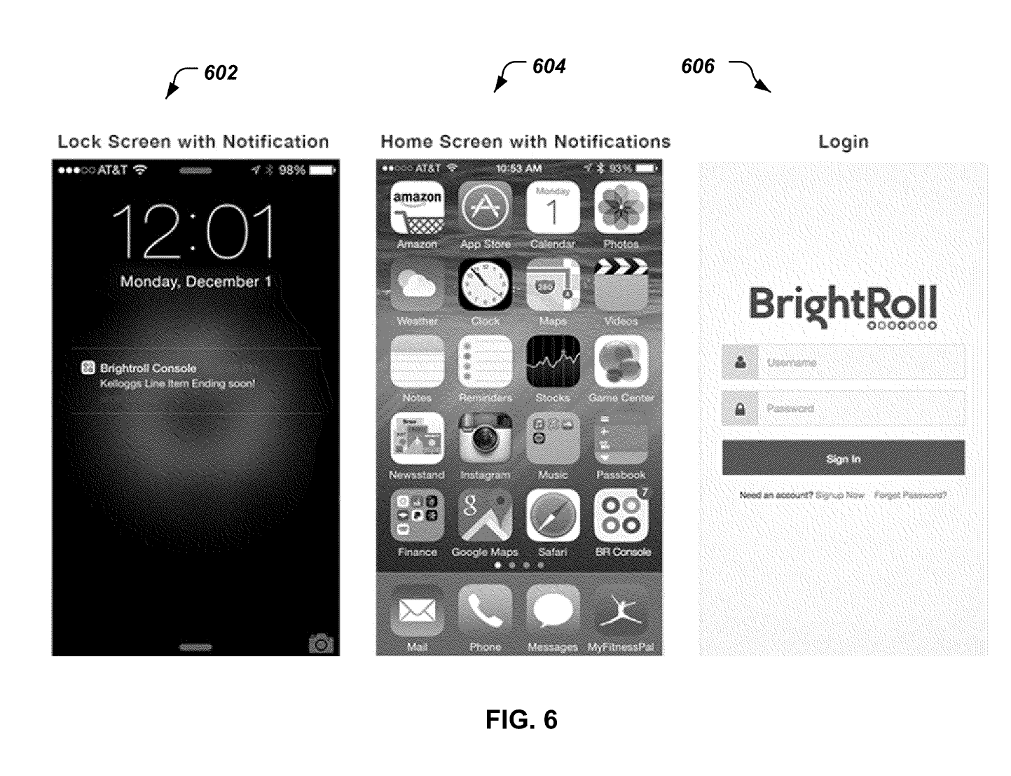

FIG. 6 shows example user interface displays (UI) of a campaign manager's mobile device. UI 602 shows an example of a notification presented to the user about an upcoming event that the user may be interested in. UI 604 shows that seven notifications are pending for the user. UI 604 is an example of informing a user that some notifications are pending for the user, when the user is logged into the mobile phone. UI 606 shows an example login screen that is presented to a user for allowing the user to access the control and management of ad campaigns. Data entry fields are provided for entry of user credentials.

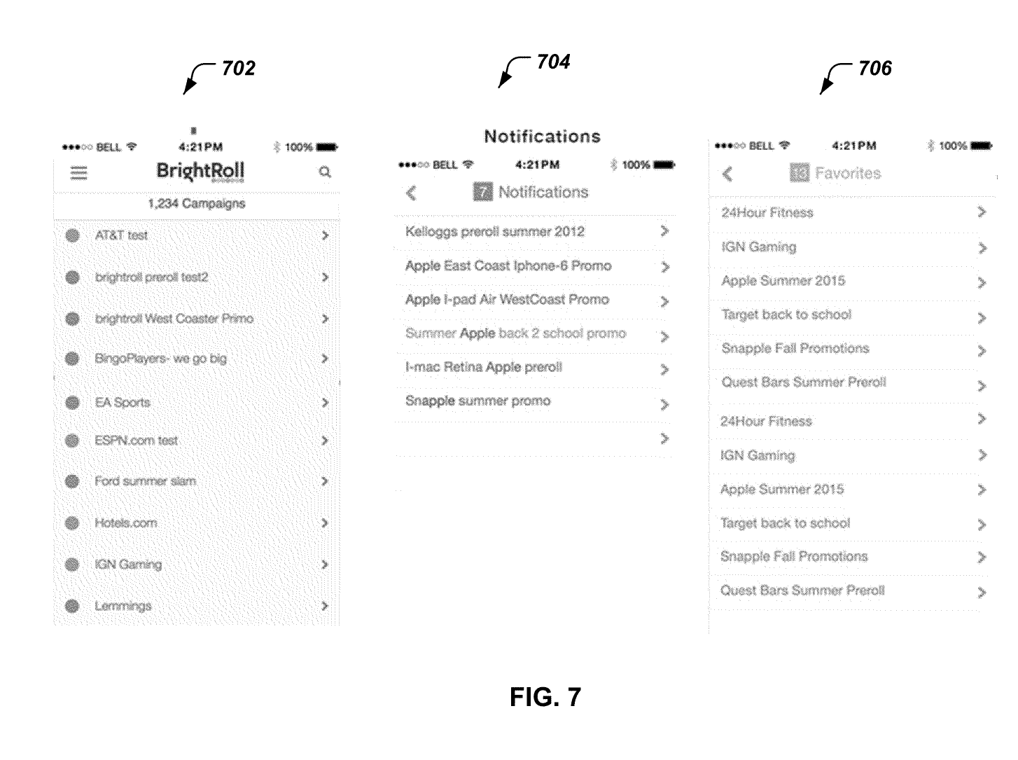

FIG. 7 shows example UIs of a campaign manager's mobile device. UI 702 depicts an overview screen in which a short summary is provided of various ad campaigns being managed by the. A header at the top of the UI 702 may provide a count of the total number of ad campaigns that the user is associated with in the system. Individual entries of campaigns may be placed on the initial scree based on different selection criteria such as most recent, user selected, most frequently occurring, etc. UI 704 shows an example screen displayed to a user when the user selects to view pending notifications. UI 706 shows a screen from which the user can check or modify status of his favorite ad campaigns. Campaigns may be designated as favorites in any suitable manner by the user.

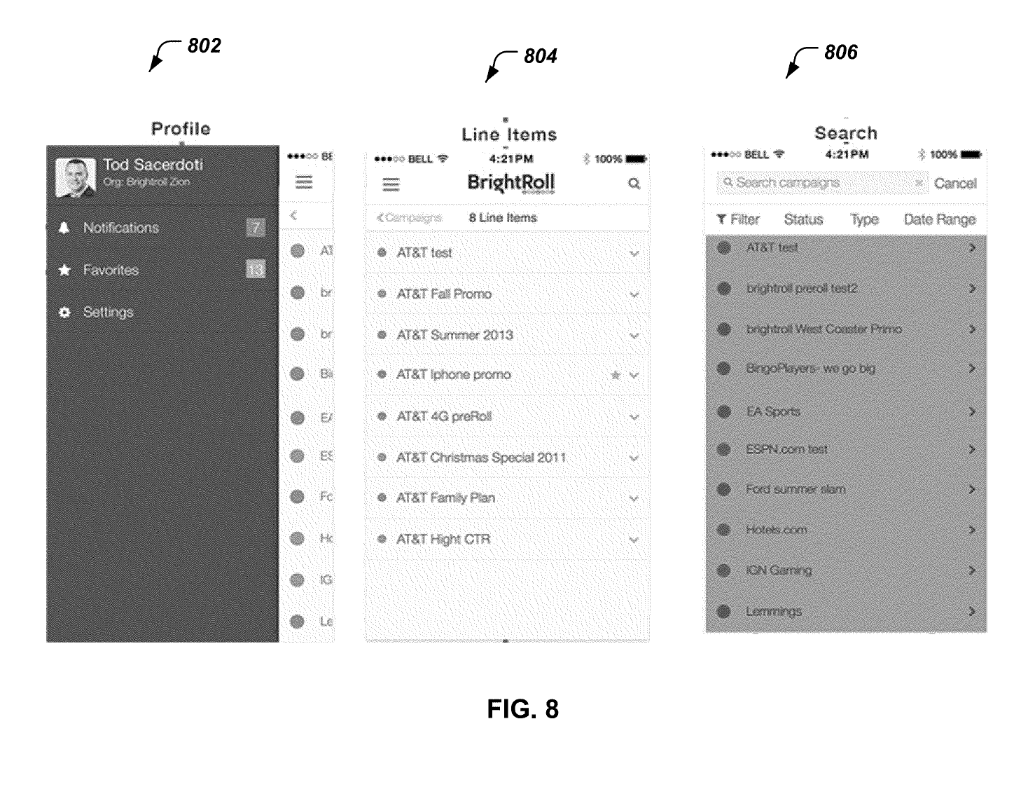

FIG. 8 shows example UIs of a campaign manager's mobile device. UI 802 shows a top level screen from which the user can verify his identity, pending notifications, number of favorites and check and modify his settings of various control and viewing options described in this document. UI 804 shows an example listing of line items relevant to the user. Some line items may have a visual indication such as an asterisk (*) to indicate recent changes or activity. UI 806 shows an example of user interaction with the line item screen to filter all viewable line items by options such as status, type, date range, and so on.

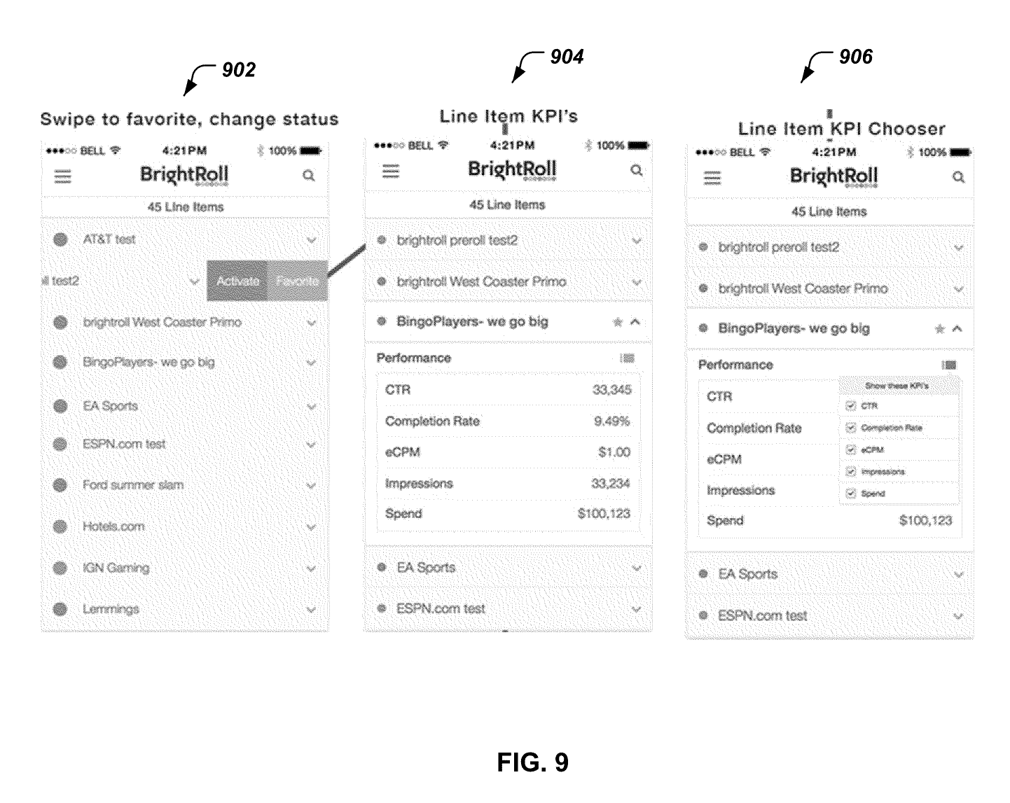

FIG. 9 shows example UIs of a campaign manager's mobile device. UI 902 shows an example of a user toggling between browsing favorite items and campaigns or line items that have changes by swapping between different options. On UI 904, a user can select a line item, which then opens a key parameter view which shows relevant statistics, the entries of which may have been pre-specified by the user, e.g., click-through rate (CTR), completion rate, eCPM, impressions, money spent, etc. The UI 906 shows an example of how a user can select which parameters to display by checking or unchecking dialog boxes for that line item.

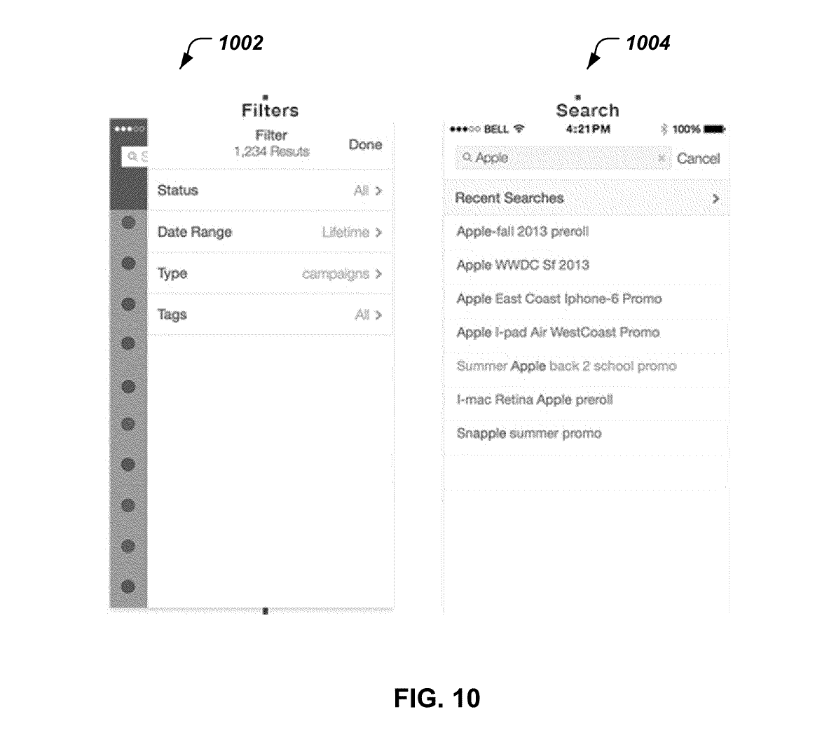

FIG. 10 shows example UIs of a campaign manager's mobile device. Using UI 1002, the user may be able to select various filters and how they are used to filter the number of items to be displayed. As depicted in UI 1004, a search function including a search box to receive text entry of a term to be searched could be provided to allow a user to search for line items or ad campaigns using partial alphanumeric entries.

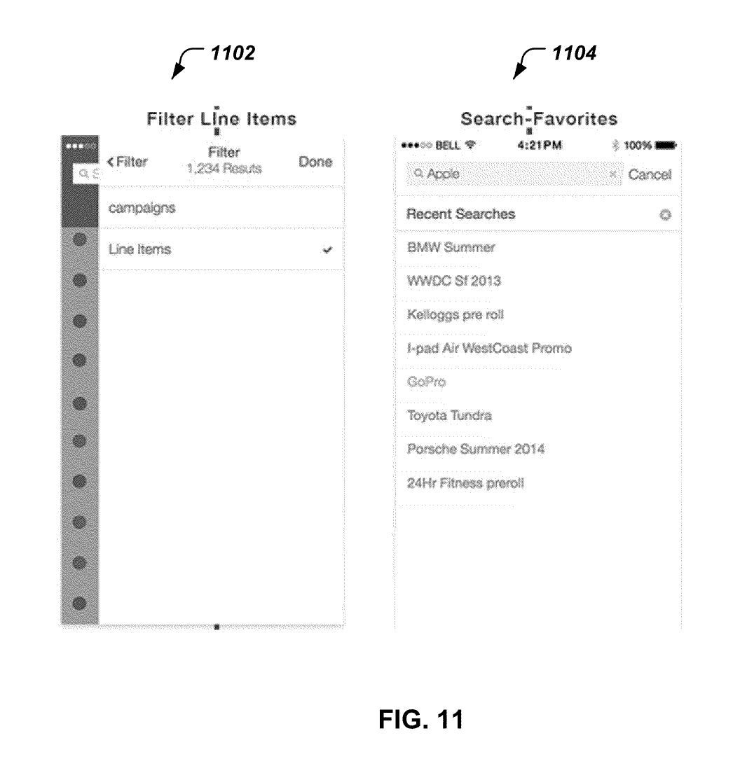

FIG. 11 shows example UIs of a campaign manager's mobile device. Using the UI 1102, e.g., the user can make a selection of whether to filter over campaigns or line items. As depicted in UI 1104, a user can view his previous searches.

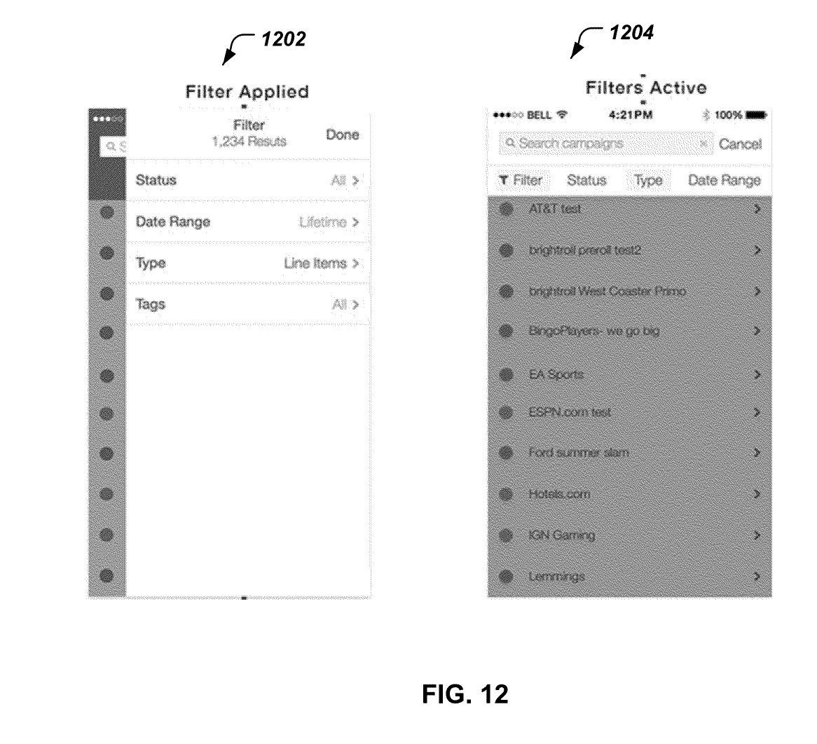

FIG. 12 shows example UIs of a campaign manager's mobile device. As shown by UI 1202, information is provided to user about which entries are currently being filtered prior to showing to the user. Upon selection of this entry, e.g., as shown in a header of UI 1204, the user can change the filtering criterion.

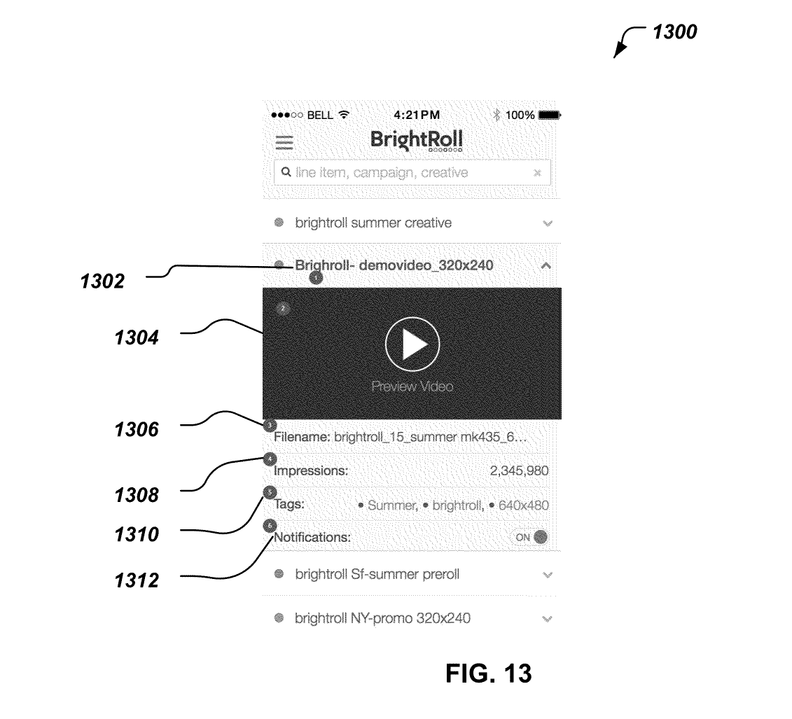

FIG. 13 shows an example UI 1300 for playing a video ad campaign creative on a campaign manager's mobile device. The UI 1300 may provide a way by which the user may be able to view a creative asset as well as preview the video or media asset that corresponds to the creative (1302). The video asset may be played back to the user in a window on the user's mobile device (1304). The user may also be able to see the actual file name of the file that was used when the video file being played back was created (1306). The UI 1300 may also provide some user-configurable KPIs for the creative being previewed (1308). A tagging feature (1310) allows a user to specify an alphanumeric string that can uniquely be associated with the creative for future search, and organization by the user. The user may also be able to set notifications for the video (1312) to catch any potential issues with the creative, such as a broken or ill-formatted media file. As shown in FIG. 13, notification could be simply a turn on/turn off feature, and the actual events to be notified could be selected by the user from another menu screen.

In some embodiments, a method of controlling an ad campaign in a video advertisement insertion system from a mobile device includes providing, on the mobile device, a notification about an event related to the ad campaign, receiving, from a user interface of the mobile device, a command for changing at least one operational parameter of the ad campaign, providing menu on the user interface to specify an attribute of the notification and controlling, based on a received menu input, the attribute of the notification. In various embodiments, the event related to the ad campaign includes at least one of: a key performance indicator, a click-through rate, a completion rate, a number of impressions, amount of money spent to date and budget left for the ad campaign.

In some embodiments, a technique for controlling operational parameters of an advertisement campaign by which video advertisements are distributed to user devices in a video advertisement system includes identifying a group of operator devices as devices that can perform control and management of the advertisement campaign, wherein the group of operator devices includes a first subset of operator devices operating at fixed locations and a second subset of operator devices operating at mobile locations, associating a given operator device from the second subset as a primary device for the advertisement campaign such that a notification for the advertisement campaign is first sent to the given operator device, the given operator device having an associated fixed location device from the first subset of operator devices, and sending the notification to other devices from the group when it is determined that the given operator device is not in a position to receive and act upon the notification. In some embodiments, the other devices to which the notification is sent are in vicinity of the associated fixed location device, e.g., other colleagues in the office.

In some embodiments, a technique for allowing management and control of a plurality of video advertisement campaigns in which video advertisements are distributed to a plurality of user devices based on an auction-based bidding advertisement insertion system, the method being implemented at a mobile device having a touchscreen display includes displaying, on an initial user interface (UI), a list of video advertisement campaigns controllable by the mobile device that have been previously selected for display on the initial UI, receiving a selection input selecting one of the video advertisement campaigns, displaying, upon receiving the selection, key performance index data associated with the selected video advertisement campaign, receiving a notification from the auction-based bidding advertisement insertion system for another video advertisement campaign, and selectively displaying, based on a pre-selected notification setting, the notification on a notification UI.

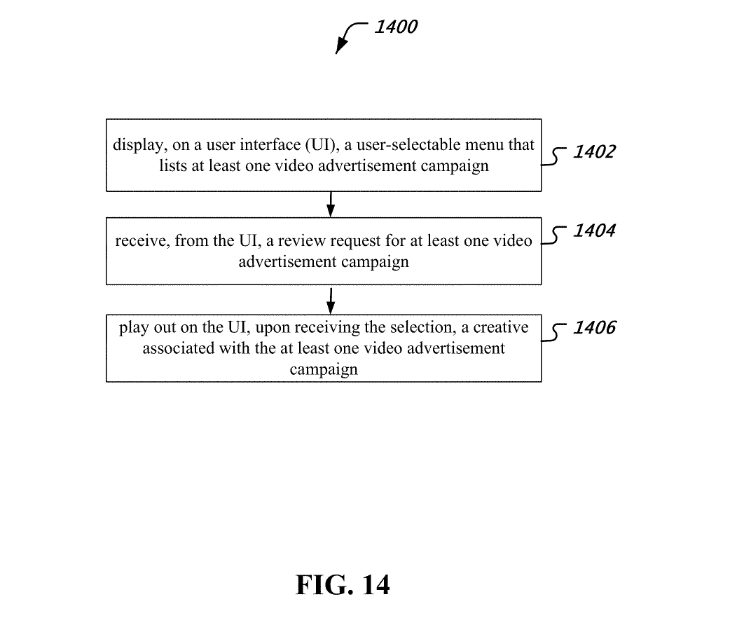

FIG. 14 shows an example method 1400 of facilitating management and control of a plurality of video advertisement campaigns in which video advertisements are distributed to a plurality of user devices in an auction-based bidding advertisement insertion system. The method 1400 may be implemented on a campaign manager's mobile device that has a touchscreen display as a user interface for displaying information to the user and to receive user inputs.

The method 1400 includes, at step 1402, displaying, on a user interface (UI), a user-selectable menu that lists at least one video advertisement campaign. Some examples of such menu are provided with respect to FIG. 6 to FIG. 13.

The method 1400 includes, at step 1404, receiving, from the UI, a review request for at least one video advertisement campaign. The request may

The method 1400 includes, at step 1406, playing out on the UI, upon receiving the selection, a creative associated with the at least one video advertisement campaign.

In some embodiments, the method 1400 may further include presenting, on the UI, key performance index data associated with the selected video advertisement campaign. As disclosed herein, e.g., in FIG. 13, the key performance index data being presented is preconfigured by a user. In some embodiments, the method 1400 further includes presenting, on the UI, a filename associated with the creative. The filename may be that of a video file used for generating the video file. In some embodiments, the method 1400 further includes monitoring the playing out for errors and logging, when an error is detected during the monitoring, the error to a log. For example, one example of an error that may be monitored and logged is when the video file is ill-formatted.

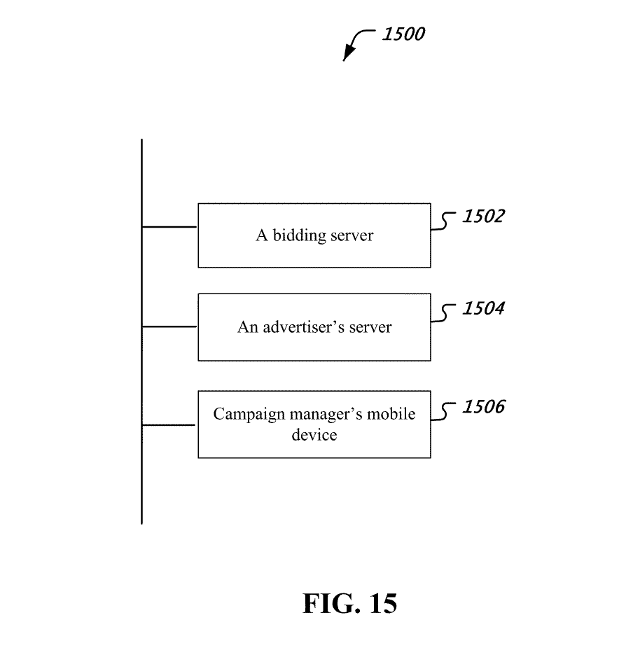

FIG. 15 shows an example video advertisement insertion system 1500. The system 1500 includes a bidding server 1502 (e.g., similar to bid server 110 of FIG. 1) that facilitates display of video advertisements to multiple user devices. The system 1500 includes an advertiser's server 1504 (e.g., similar to third party bidder module 116 of FIG. 1) that bids for placement of video advertisements by the bidding server according to a plurality of video advertisement campaigns. The system 1500 includes a mobile device 1506 (e.g., similar to control device 212 of FIG. 2) that controls execution of the plurality of advertisement campaigns by displaying, on a UI, a user-selectable menu that lists at least one video advertisement campaign, receiving, from the UI, a review request for at least one video advertisement campaign, and playing out on the UI, upon receiving the selection, a creative associated with the at least one video advertisement campaign.

It will be appreciated that several techniques and UIs for enabling control of video ad insertion campaigns from mobile devices are disclosed. In one example aspect, a video from the advertisement campaign can be previewed or reviewed on the campaign manager's mobile device for quality and errors.

The disclosed and other embodiments and the functional operations and modules described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “apparatus” encompasses all devices and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

Various embodiments described herein are described in the general context of methods, modules or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

For example, one aspect of the disclosed embodiments relates to a computer program product that is embodied on a non-transitory computer readable medium. The computer program product includes program code for carrying out any one or and/or all of the operations of the disclosed embodiments.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and their practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method of facilitating management and control of a plurality of video advertisement campaigns in which video advertisements are distributed to a plurality of user devices in an auction-based bidding advertisement insertion system, the method being implemented at a mobile device having a touchscreen display, comprising:
displaying, on a user interface (UI), a user-selectable menu that lists at least one video advertisement campaign;
receiving, from the UI, a review request for at least one video advertisement campaign; and
playing out on the UI, upon receiving the selection, a creative associated with the at least one video advertisement campaign.

2. The method of claim 1, further including:
presenting, on the UI, key performance index data associated with the selected video advertisement campaign.

3. The method of claim 2, wherein the key performance index data being presented is preconfigured by a user.

4. The method of claim 1, further including:
presenting, on the UI, a filename associated with the creative.

5. The method of claim 4, wherein the filename is that of a video file used for the creative.

6. The method of claim 1, further including:
monitoring the playing out for errors; and
logging, when an error is detected during the monitoring, the error to a log.

7. The method of claim 6, wherein the monitoring includes monitoring for an ill-formatting error in the creative.

8. An apparatus for management and control of a plurality of video advertisement campaigns in which video advertisements are distributed to a plurality of user devices in an auction-based bidding advertisement insertion system, the apparatus comprising a memory storing instructions and a processor for reading the instructions from the memory and implementing a method, comprising:
displaying, on a user interface (UI), a user-selectable menu that lists at least one video advertisement campaign;
receiving, from the UI, a review request for at least one video advertisement campaign; and
playing out on the UI, upon receiving the selection, a creative associated with the at least one video advertisement campaign.

9. The apparatus of claim 1, wherein the method further includes:
presenting, on the UI, key performance index data associated with the selected video advertisement campaign.

10. The apparatus of claim 9, wherein the key performance index data being presented is preconfigured by a user.

11. The apparatus of claim 9, wherein the method further includes:
presenting, on the UI, a filename associated with the creative.

12. The apparatus of claim 11, wherein the filename is that of a video file used for the creative.

13. The apparatus of claim 9, wherein the method further includes:
monitoring the playing out for errors; and
logging, when an error is detected during the monitoring, the error to a log.

14. The apparatus of claim 13, wherein the monitoring includes monitoring for an ill-formatting error in the creative.

15. A video advertisement insertion system, comprising
a bidding server that facilitates display of video advertisements to multiple user devices;
an advertiser's server that bids for placement of video advertisements by the bidding server according to a plurality of video advertisement campaigns; and
a mobile device module that controls execution of the plurality of advertisement campaigns by:
displaying, on a user interface (UI), a user-selectable menu that lists at least one video advertisement campaign;
receiving, from the UI, a review request for at least one video advertisement campaign; and
playing out on the UI, upon receiving the selection, a creative associated with the at least one video advertisement campaign.

16. The system of claim 15, wherein the mobile device further:
presents, on the UI, key performance index data associated with the selected video advertisement campaign.

17. The system of claim 15, wherein the key performance index data being presented is preconfigured by a user.

18. The system of claim 15, wherein the mobile device further:
presents, on the UI, a filename associated with the creative.

19. The system of claim 18, wherein the filename is that of a video file used for the creative.

20. The system of claim 15, wherein the mobile device further:
monitors the playing out for errors; and
logs, when an error is detected during the monitoring, the error to a log.
